(19) United States
(12) Patent Application Publication
(10) Pub. No.: US 2004/0223592 A1
(43) Pub. Date: Nov. 11, 2004

(54) Telephone test set with attached volt-ohm meter

(76) Inventors: Frederick James Diggle, Birmingham, AL (US); Paul Brent Rivers, Cullman, AL (US)

Correspondence Address: KIRKPATRICK & LOCKHART LLP, 535 SMITHFIELD STREET, PITTSBURGH, PA, 15222, US

(21) Appl. No.: 10/429,393

(22) Filed: May 5, 2003

(51) Int. Cl. H04M 1/24; H04M 3/08; H04M 3/22

(52) U.S. Cl. 379/21

(57) ABSTRACT

A telephone test set including a telephone tester portion and a volt-ohm meter portion attached to the telephone tester portion.

### BACKGROUND

The present invention is directed generally and in various embodiments to a telephone test set with attached volt-ohm meter.

Telephone test sets (also known as telephone butt sets or “buttinsky” sets) are used by telecommunications technicians to troubleshoot and service telecommunications lines. Technicians oftentimes clip a test set to their tool belt or clothing and thus have access to the test set when needed in the field. Another tool used frequently by a telecommunications technician is a volt-ohm meter. Technicians employ volt-ohm meters for a variety of tasks, including to find shorts, grounds, and open circuits in telecommunications circuits. Many volt-ohm meters are not generally adapted to be attached to a technician's tool belt or clothing and, thus, technicians often leave such meters in an inconvenient place while operating in the field and thus do not have easy access to the meters when needed.

### SUMMARY

In one embodiment, the present invention is directed to a telephone test set including a telephone tester portion and a volt-ohm meter portion attached to the telephone tester portion.

In one embodiment, the present invention is directed to a telephone test set including a telephone tester portion having a DTMF keypad, a speaker, and a microphone, and a volt-ohm meter portion attached to the telephone tester portion, wherein the volt-ohm meter portion is configured to measure at least one of voltage, resistance and current.

In one embodiment, the present invention is directed to a telephone test set including telephone line testing means and volt-ohm meter means attached to the telephone line testing means.

### BRIEF DESCRIPTION OF THE DRAWINGS

Further advantages of the present invention may be better understood by referring to the following description taken in conjunction with the accompanying drawings, in which:

FIG. 1 is a diagram illustrating a front view of a telephone test set according to one embodiment of the present invention;

FIG. 2 is a diagram illustrating a rear view of the telephone test set according to one embodiment of the present invention; and

FIG. 3 is a diagram illustrating a side view of the volt-ohm meter portion according to one embodiment of the present invention.

### DESCRIPTION

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these and other elements may be desirable. However, because such elements are well known in the art, and because they do not facilitate a better understanding of the present invention, a discussion of such elements is not provided herein.

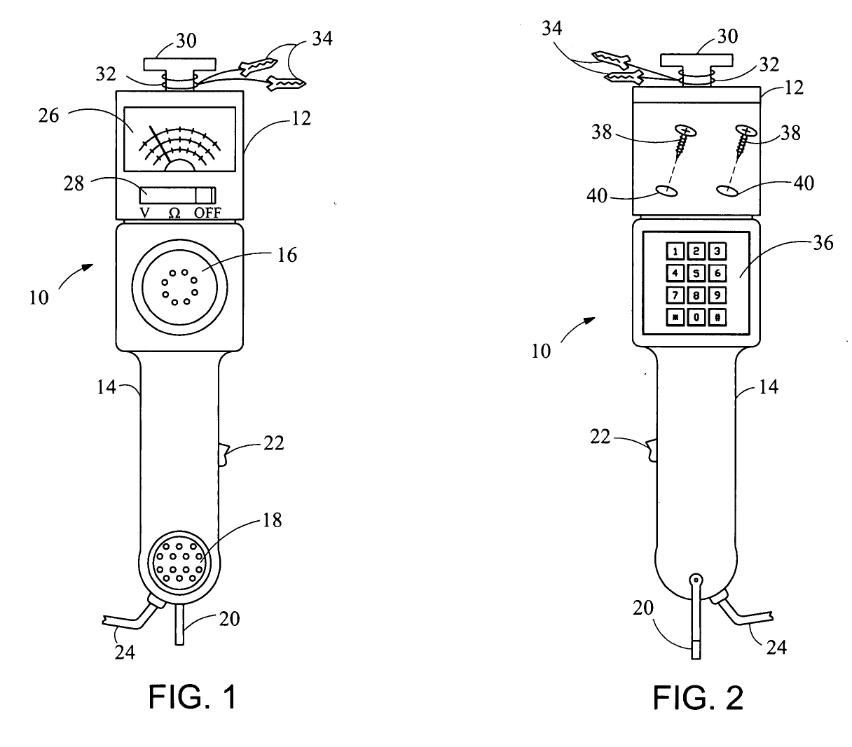

FIG. 1 is a diagram illustrating a front view of a telephone test set 10 according to one embodiment of the present invention. The test set 10 includes a volt-ohm meter portion 12 and a telephone tester portion 14. The telephone tester portion 14 may be any type of telephone test set such as, for example, those manufactured by Harris Corporation. The volt-ohm meter portion 12 may be any type of commercially-available digital or analog volt-ohm meter such as, for example, a 310 Series Handheld Analog VOM manufactured by Triplett or the volt-ohm meter portion 12 may be any type of digital or analog volt-ohm meter that is constructed specifically to be attached to the telephone tester portion 14. In the embodiment where the volt-ohm meter portion 12 is constructed specifically for attachment to the telephone tester portion 12, the shape of the volt-ohm meter portion 12 can be fabricated or molded to conform to the shape or contour of the telephone tester portion 14.

The telephone tester portion 14 includes a speaker 16 and a microphone 18. The tester portion 14 also includes a belt clip 20, talk button 22, and a tester lead 24. A portion of the tester lead 24 is illustrated in FIG. 1. It can be understood that the tester lead 24 would be terminated by electrically-conductive attachment devices such as, for example, alligator clips.

The volt-ohm meter portion 12 may include a readout 26 and a selector switch 28 that may be used to select the function desired (e.g. voltage or resistance measurements). The volt-ohm meter portion 12 may also include a cord wrap 30 on which electrical test leads 32 are wound. The test leads 32 may be terminated by electrically-conductive attachment devices such as alligator clips 34.

FIG. 2 is a diagram illustrating a rear view of the telephone test set 10 according to one embodiment of the present invention. The rear of the test set 10 includes an input device 36 such as a dual tone multi-frequency (DTMF) keypad. FIG. 2 illustrates one embodiment for attaching the volt-ohm meter portion 12 to the telephone tester portion 14. Attachment devices 38, such as screws or bolts, are inserted through recesses 40 in the volt-ohm meter portion 12 and extend into the telephone tester portion 14, thus securing the volt-ohm meter portion 12 to the telephone tester portion 14. The recesses 40 and/or corresponding holes (not shown) in the telephone tester portion 14 that accept the attachment devices 38 may be pre-formed into the volt-ohm meter portion 12 and/or the telephone tester portion 14. In another embodiment, the recesses 40 and/or corresponding holes in the telephone tester portion 14 are drilled into the volt-ohm meter portion 12 and/or the telephone test set portion 14 at the time the volt-ohm meter portion 12 is attached to the telephone tester portion 14.

In one embodiment, the volt-ohm portion 12 is attached using attachment devices 38 that extend through recesses 40 and into holes in the telephone tester portion 14 that are formed during manufacture of the telephone tester portion 14 to hold various portions of the telephone tester portion 14 (e.g. housing portions) together with a fastener. In such an embodiment, the pre-existing fasteners may be removed prior to attaching the volt-ohm portion 12 to the telephone tester portion 14 using the attachment devices 38. In other embodiments, the volt-ohm portion 12 is attached to the telephone tester portion 14 using a glue such as, for example, epoxy, or using a plastic weld.

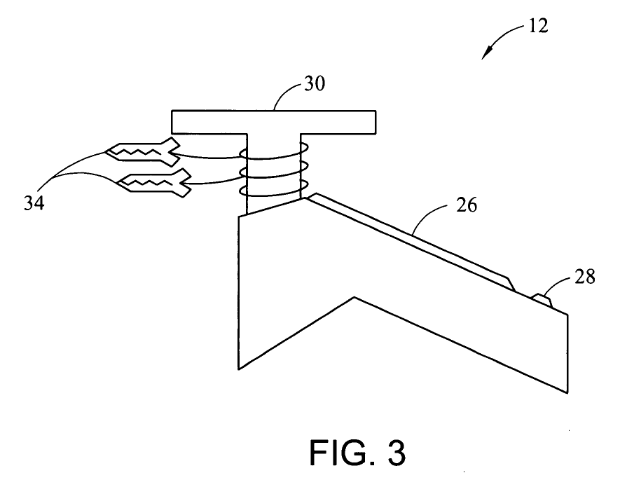

FIG. 3 is a diagram illustrating a side view of the volt-ohm meter portion 12 according to one embodiment of the present invention. As illustrated in FIG. 3, the volt-ohm meter portion 12 is shown as fabricated or molded to conform to the shape or contour of the telephone tester portion 14.

While several embodiments of the invention have been described, it should be apparent, however, that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

What is claimed is:

1. A telephone test set, comprising:
a telephone tester portion; and
a volt-ohm meter portion attached to the telephone tester portion.

2. The telephone test set of claim 1, wherein the volt-ohm meter portion includes an analog volt-ohm meter

3. The telephone test set of claim 1, wherein the volt-ohm meter portion includes a digital volt-ohm meter.

4. The telephone test set of claim 1, further comprising at least one test lead attached to the volt-ohm meter portion.

5. The telephone test set of claim 1, wherein the volt-ohm meter portion is attached to the telephone tester portion via at least one screw.

6. The telephone test set of claim 1, wherein the volt-ohm meter portion is attached to the telephone tester portion via glue.

7. The telephone test set of claim 1, wherein the volt-ohm meter portion is attached to the telephone tester portion via a plastic weld.

8. The telephone test set of claim 1, wherein the volt-ohm meter portion is shaped such that it is molded to fit the telephone tester portion.

9. The telephone test set of claim 1, wherein the volt-ohm meter portion is attached to the telephone tester portion via a fastener inserted into a pre-formed hole in the telephone tester portion.

10. The telephone test set of claim 1, wherein the telephone tester portion includes a DTMF keypad.

11. A telephone test set, comprising:
a telephone tester portion having a DTMF keypad, a speaker, and a microphone; and
a volt-ohm meter portion attached to the telephone tester portion, wherein the volt-ohm meter portion is configured to measure at least one of voltage, resistance and current.

12. The telephone test set of claim 11, wherein the volt-ohm meter portion includes an analog volt-ohm meter.

13. The telephone test set of claim 11, wherein the volt-ohm meter portion includes a digital volt-ohm meter.

14. The telephone test set of claim 11, wherein the telephone tester portion includes a belt clip.

15. The telephone test set of claim 11, wherein the volt-ohm meter portion is attached to the telephone tester portion via a fastener.

16. The telephone test set of claim 11, wherein the volt-ohm meter portion is attached to the telephone tester portion via glue.

17. The telephone test set of claim 11, wherein the volt-ohm meter portion is attached to the telephone tester portion via a plastic weld.

18. A telephone test set, comprising:
telephone line testing means; and
volt-ohm meter means attached to the telephone line testing means.

19. The telephone test set of claim 18, wherein the volt-ohm meter means includes one of an analog volt-ohm meter and a digital volt-ohm meter.

20. The telephone test set of claim 18, wherein the telephone line testing means includes a telephone butt set.
